(19) United States
(12) Patent Application Publication
(10) Pub. No.: US 2017/0114892 A1
(43) Pub. Date: Apr. 27, 2017

(54) SHIFT LEVER DEVICE

(71) Applicant: FUJI KIKO Co., Ltd., Shizuoka (JP)

(72) Inventor: Tsuyoshi ABE, Shizuoka (JP)

(73) Assignee: FUJI KIKO Co., Ltd., Shizuoka (JP)

(21) Appl. No.: 15/293,362

(22) Filed: Oct. 14, 2016

(30) Foreign Application Priority Data
Oct. 27, 2015 (JP) 2015-210416

(51) Int. Cl. F16H 61/22; F16H 61/24; F16H 59/10

(52) U.S. Cl. CPC F16H 61/22; F16H 59/10; F16H 61/24; F16H 2059/026

(57) ABSTRACT

A cable coupler is provided on a front side in a swinging direction of a shift lever, and a check mechanism is provided on a rear side thereof, respectively. Thus, the cable coupler, the shift lever, and the check mechanism are disposed along the swinging direction of the shift lever. A unit base including a shift lock mechanism is provided separately from a casing, and is housed and disposed in an opening of a right side wall of the casing. The opening is continuous to a detent hole. A first flange and a second flange are formed on peripheral edges of the detent hole.

### CROSS REFERENCE TO RELATED APPLICATION

The present application is based on, and claims priority from Japanese Patent Application No. 2015-210416, filed Oct. 27, 2015, the disclosure of which is hereby incorporated by reference herein in its entirety.

### TECHNICAL FIELD

The present invention relates to a shift lever device which performs shift range switching of an automatic transmission.

### BACKGROUND ART

A shift lever device used for operating an automatic transmission of an automobile is likely to face a problem of a small installation space particularly when the device is disposed in a center console, because cup holders and the like are also to be disposed therein. Given this situation, there is an ongoing study of size reduction by further reducing a width of the device corresponding to a vehicle width direction.

To deal with the size reduction of the shift lever device, in Patent Literature 1 (Japanese Patent Application Publication No. 2015-98242), a recessed portion that is recessed outward is provided on an inner surface of a side wall of a casing to which a shift lever is swingably attached, and a check block constituting a check mechanism is disposed in the recessed portion. The check mechanism is configured to impart click feeling (moderation feeling) to each of multiple positions set within a swinging range of the shift lever when the shift lever is put into a swing operation.

### SUMMARY

Although shift lever devices have been subjected to attempts for size reduction as mentioned above, there is a demand for further reduction in size.

In view of the above, an object of the present invention is to further reduce a shift lever device in size.

The present invention is a shift lever device including: a casing attached to a vehicle body; a shift lever inserted into a shift hole having a shape of an elongated hole opened to an upper surface of the casing and configured to swing along the shift hole; a check mechanism provided between the casing and the shift lever, and configured to impart click feeling to each of positions set within a swinging range of the shift lever when the shift lever is put into a swing operation; and a shift lock mechanism configured to come into engagement with the shift lever and thus to restrict movement of the shift lever from a parking position to another position being the positions set within the swinging range of the shift lever. The check mechanism includes a check member provided to the shift lever, and held while being biased in a protruding direction, and a check block provided to the casing and having a check groove to be pressed by the check member which swings together with the shift lever, a coupler for a cable, of which one end is connected to a transmission, is integrally provided on one side in a swinging direction of the shift lever, and a guide member configured to guide the check member is integrally provided on another side in the swinging direction of the shift lever, the shift lock mechanism includes a lock member configured to come into engagement with a positioning pin located at the parking position of the shift lever and thus to block movement in an axial direction of the positioning pin, and a drive unit configured to move the lock member to an unlocked position where the lock member does not come into engagement with the positioning pin, the shift lock mechanism is attached to a unit base provided separately from the casing, the casing is formed such that a width in a left-right direction of the shift hole is equal to a width between inner surfaces of a pair of left and right side walls of the casing, and that a through-hole in which the unit base is to be housed and disposed is provided in one of the pair of left and tight side walls of the casing, a detent hole is penetratingly provided in each of the pair of left and right side walls of the casing, the detent hole being provided with a detent groove to come into engagement with the positioning pin in the swinging direction of the shift lever, one of the detent holes provided in the pair of left and right side walls of the casing is continuous to the through-hole, the detent hole continuous to the through-hole includes a flange provided on an peripheral edge of the detent hole and erected from the side wall, and a leading end position of the flange is set at the same position as positions of respective end portions of the lock member, the drive unit, and the unit base projecting from the side wall.

In the present invention, the coupler for a cable is disposed on the one side in the swinging direction of the shift lever, and the guide member of the check mechanism is disposed on the other side thereof, respectively, and the unit base to which the shift lock mechanism is attached is housed and disposed in the through-hole in the side wall of the casing. Here, the width in the left-right direction of the shift hole in the casing is set equal to the width between the inner surfaces of the pair of left and right side walls of the casing. Accordingly, it is possible to further reduce the interval between the pair of left and right side walls, and to achieve reduction in size while reducing the width in the vehicle width direction of the shift lever device.

Moreover, in the present invention, the leading end position of the flange provided on the peripheral edge of the detent hole is set at the same position as the respective end portions of the lock member, the drive unit, and the unit base projecting from the side wall. This makes it possible to reduce the width in the vehicle width direction of the shift lever device while securing rigidity of the casing, even when the casing includes the through-hole which is continuous to the detent hole and provided for housing and disposing the unit base.

### BRIEF DESCRIPTION OF DRAWINGS

FIG. 1 is a perspective view showing a state in which a shift lever device according to an embodiment of the present invention is disposed in a center console of an automobile.

FIG. 2 is a plan view of the shift lever device together with the center console in FIG. 1.

FIG. 3 is a side view of the shift lever device together with the center console in FIG. 1 viewed from the right side of the automobile.

FIG. 4 is a rear view of the shift lever device together with the center console in FIG. 1 viewed from the rear side of the automobile.

FIG. 5 is a cross-sectional view taken along the A-A line in FIG. 4 and deprived of the center console.

FIG. 6 is a cross-sectional view taken along the B-B line in FIG. 3 and deprived of the center console.

FIG. 7 is a front view of the shift lever device viewed from the front side of the automobile.

FIG. 8 is a perspective view of a lock mechanism unit to be attached to a casing of the shift lever device.

FIG. 9 is a side view of the lock mechanism unit in FIG. 8.

FIG. 10 is a plan view showing a state in which the lock mechanism unit in FIG. 8 is attached to a right side wall of the casing.

FIG. 11 is a perspective view of the casing of the shift lever device.

FIG. 12 is a perspective view of the casing viewed from a different direction from FIG. 11.

FIG. 13 is a side view of the casing in FIG. 11.

### DESCRIPTION OF EMBODIMENTS

An embodiment of the present invention will be described below with reference to the drawings.

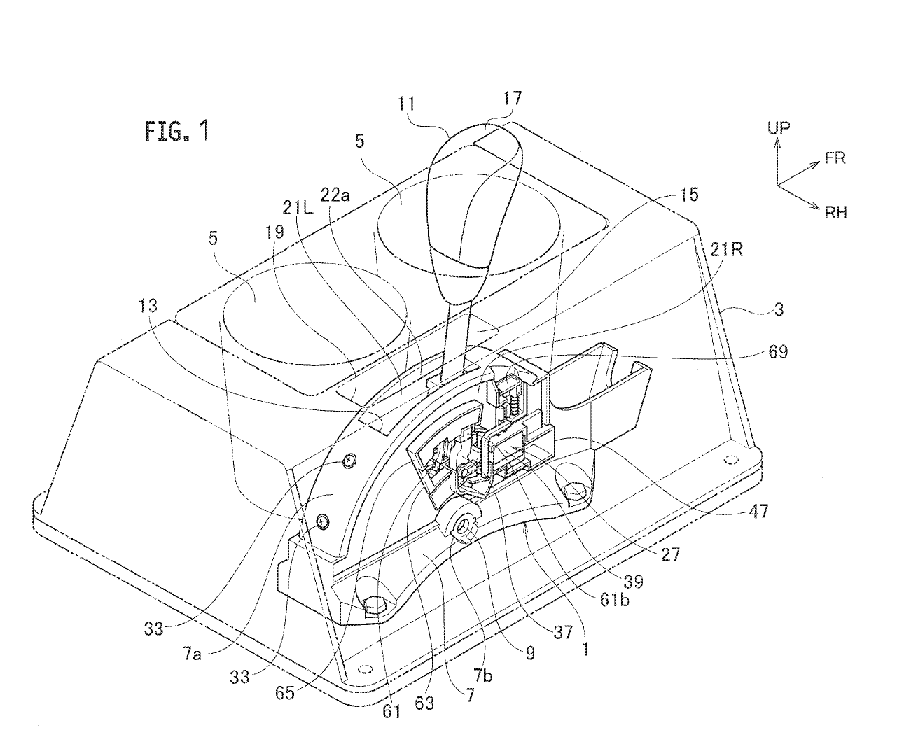

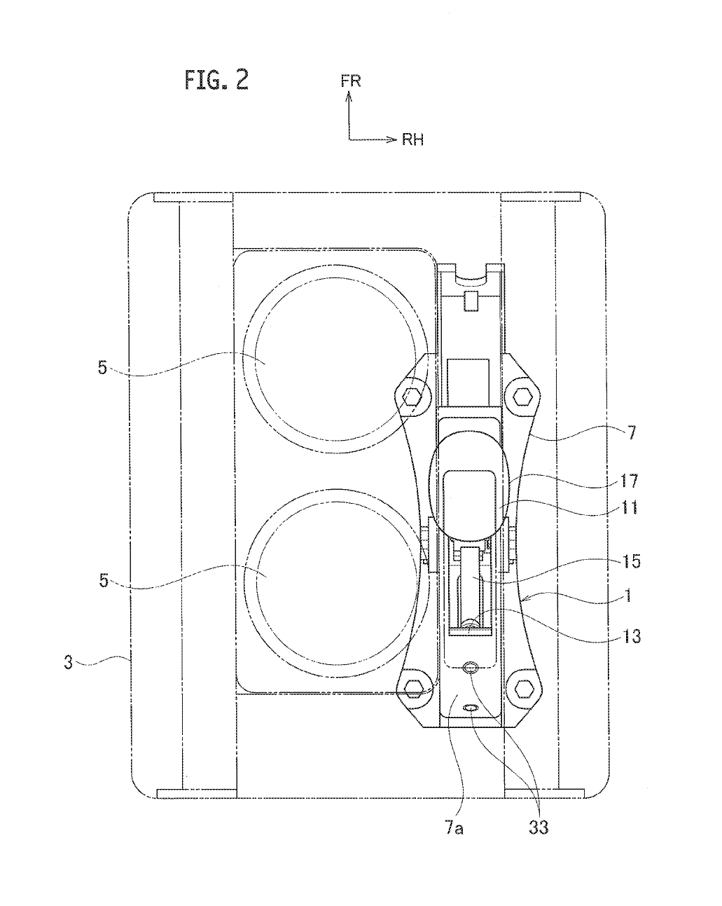

FIGS. 1 to 4 illustrate a shift lever device 1 according to an embodiment of the present invention in a state of being provided at a region of a center console 3 of an automobile as a vehicle. In each of the drawings, an arrow FR indicates a front side of the automobile, an arrow RH indicates a right side of the automobile, and an arrow UP indicates an upper side of the automobile, respectively. The expression “front-back direction” in the following description means a front-back direction of the automobile unless otherwise specified.

Two cup holders 5 are provided along the front-back direction in the center console 3 at a region slightly displaced to the left from the center in a vehicle width direction. The shift lever device 1 is provided in the vicinity of a right side region in the vehicle width direction of the cup holders 5.

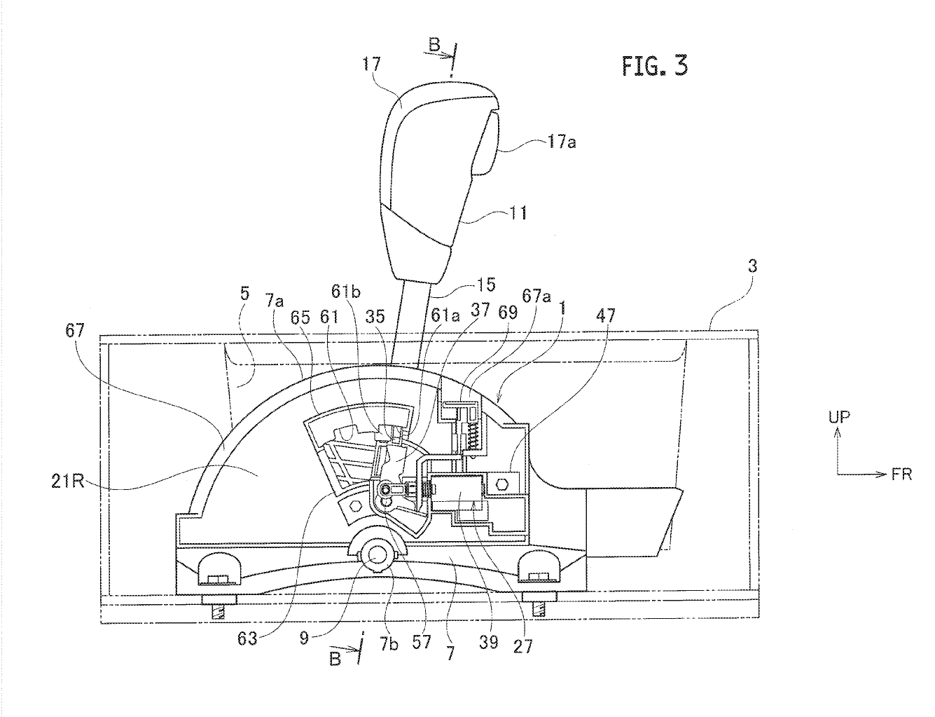

The shift lever device 1 includes a casing 7, and a shift lever 11 which swings in the front-back direction relative to the casing 7 and around a support shaft 9 shown in FIGS. 1 and 3. The casing 7 has a shape of a box, of which upper surface 7a constituting a ceiling portion has an arc shape that protrudes outward. The support shaft 9 located at a base portion of the shift lever 11 is pivotally supported in a turnable manner by a bearing 7b provided at a lower part of the casing 7.

As shown in FIG. 1, a shift hole 13 having a shape of an elongated hole that is long in the front-back direction is provided in the upper surface 7a of the casing 7, and a hollow cylinder 15 of the shift lever 11 is inserted into the shift hole 13. A shift knob 17 is provided at a leading end of the cylinder 15. An elongated hole 19 into which the cylinder 15 is to be inserted is also formed in an upper surface of the center console 3 corresponding to the shift hole 13 in the casing 7.

The shift hole 13 is opened on the upper surface 7a along left and right side walls 21L and 21R which are parallel to each other. The shape and position of the shift hole 13 are defined such that inner surfaces of the two side walls 21L and 21R are formed as opening edges 22a, and that the opening edges 22a and the inner surfaces of the two side walls 21L and 21R are closely arranged at prescribed intervals with respect to a swing trajectory of the shift lever 11.

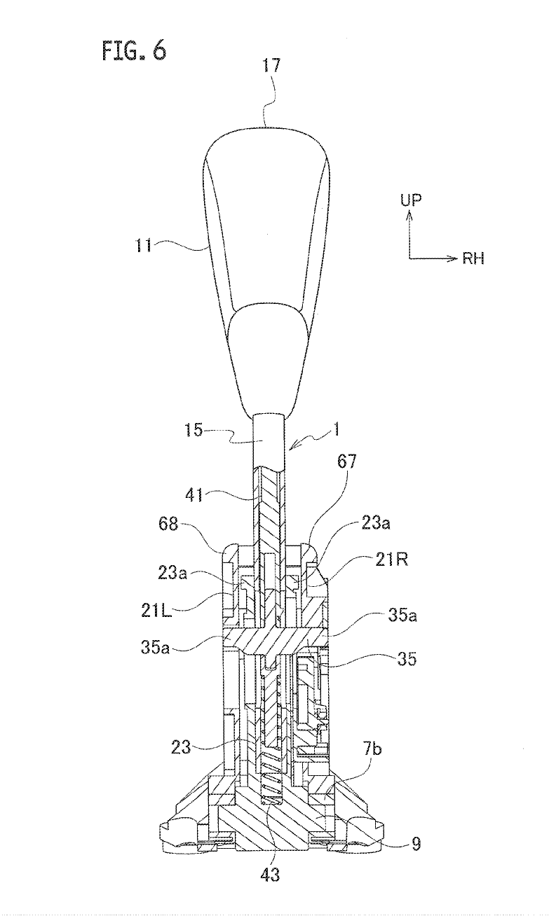

Note that the intervals between the swing trajectory of the shift lever 11 and the opening edges 22a are set so as not to bring the shift lever 11 into sliding contact with the two side walls 21L and 21R when the shift lever 11 is put into a swing operation. Moreover, the intervals are set such that, when a load in a left-right direction is applied to the shift lever 11, engagement portions 23a (FIG. 6) formed on a lever body 23 located at a base portion of the shift lever 11 come into contact with the opening edges 22a, and the shift lever 11 is thus supported by the opening edges 22a. The lever body 23 is attached integrally to a lower part of the cylinder 15, and the engagement portions 23a are formed at an upper end portion of the lever body 23 in such a way as to project slightly in the left-right directions.

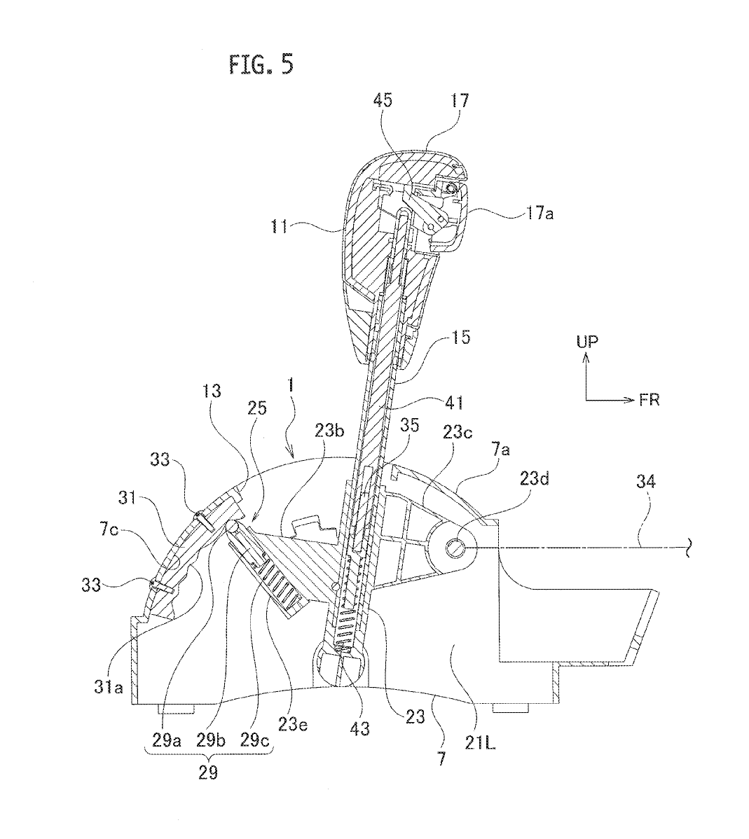

As shown in FIG. 5, the shift lever device 1 includes a check mechanism 25 disposed between the casing 7 and the shift lever 11. The check mechanism 25 is configured to impart click feeling to each of positions (a parking position, a reverse position, a neutral position, and a drive position) set within a swinging range of the shift lever 11 when the shift lever 11 is put into the swing operation.

Moreover, as shown in FIGS. 1 and 3, the shift lever device 1 is provided with a shift lock mechanism 27 in order to avoid unintentional movement from the parking position to any other positions.

As shown in FIG. 5, the check mechanism 25 includes a check member 29 disposed on a rear side of and provided adjacent to the shift lever 11, and a check block 31 provided adjacent to the casing 7.

In the check member 29, a check ball 29a constituting a tip end portion is held while being biased by a check spring 29c through the intermediary of a check pin 29b. The check ball 29a, the check pin 29b, and the check spring 29c are housed and disposed in a cylinder 23e that serves as a guide member. The cylinder 23e is formed integrally to the lever body 23 of the shift lever 11 through the intermediary of a rear extension 23b. Thus, the check ball 29a can project outward in a radial direction starting from the support shaft 9 as the center.

The check block 31 is fixed to a concave inner surface 7c at a portion of the casing 7 in the vicinity of a rear side of the shift hole 13 by using screws 33. Check grooves 31a are formed in an inner side surface of the check block 31 located opposite from the concave inner surface 7c of the casing 7. The check grooves 31a are located opposite to the check member 29 that swings together with the shift lever 11, and recesses are formed at regions corresponding to the respective positions.

By adopting the above-described configuration, when the shift lever 11 is put into the swing operation, the check member 29 swings together with the shift lever 11 and the check ball 29a presses and slides on the check grooves 31a. Then, the check mechanism 25 imparts click feeling at the time of a change from one position to another position by the check ball 29a moving across a protrusion between the recesses provided for the one position to the other position.

Meanwhile, as shown in FIG. 5, the lever body 23 of the shift lever 11 is provided with a front extension 23c, which is located on a front side opposite from the rear extension 23b. A cable coupler 23d serving as a coupler is integrally provided to a front end of the front extension 23c. One end of a cable 34 is connected to a not-illustrated transmission while another end thereof is coupled to the cable coupler 23d.

Thus, the cable coupler 23d for the cable, of which one end is connected to the transmission, is integrally provided on one side in a swinging direction of the shift lever 11, while the cylinder 23e which guides the check pin 29b of the check mechanism 25 is integrally provided on the other side in the swinging direction thereof.

Next, a description will be given of the shift lock mechanism 27 shown in FIGS. 1 and 3.

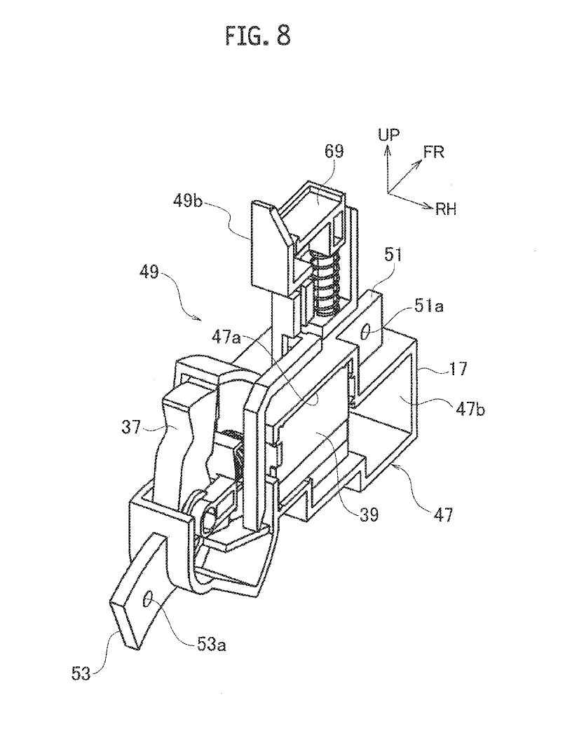

As shown in FIGS. 8 to 10, the shift lock mechanism 27 includes a lock member 37. The lock member 37 comes into engagement with a positioning pin 35 (FIGS. 3, 5, and 6) of the shift lever 11 located at the parking position and thus blocks movement of the positioning pin 35. The shift lock mechanism 27 further includes a solenoid 39 serving as a drive unit, which moves the lock member 37 to an unlocked position where the lock member 37 does not come into engagement with the positioning pin 35.

As shown in FIG. 6, the positioning pin 35 includes protrusions 35a which protrude in the left-right directions. The positioning pin 35 can move together with a positioning rod 41 housed in the cylinder 15 of the shift lever 11, and freely in an axial direction of the positioning rod 41 relative to the cylinder 15.

In the cylinder 15, a positioning spring 43 formed from a coil spring is housed on the opposite side from the positioning rod 41 while interposing the positioning pin 35 in between. The positioning pin 35 and the positioning rod 41 are held while being biased toward the shift knob 17 by the positioning spring 43.

The positioning pin 35 is disposed in such a way as to be freely reciprocable together with the positioning rod 41 between an engagement position set on the leading end side of the cylinder 15 and a release position set on a base end side of the cylinder 15. At this time, the positioning pin 35 is held at the engagement position while being biased by the positioning spring 43.

When a driver presses a knob button 17a (FIGS. 3 and 5) located on the shift knob 17, the positioning rod 41 moves downward through a button link 45 shown in FIG. 5, and the positioning pin 35 moves to the release position down below in accordance therewith. As the driver stops pressing the knob button 17a, the positioning pin 35 returns to the engagement position by the biasing force of the positioning spring 43, and meanwhile, the knob button 17a moves back to the initial position.

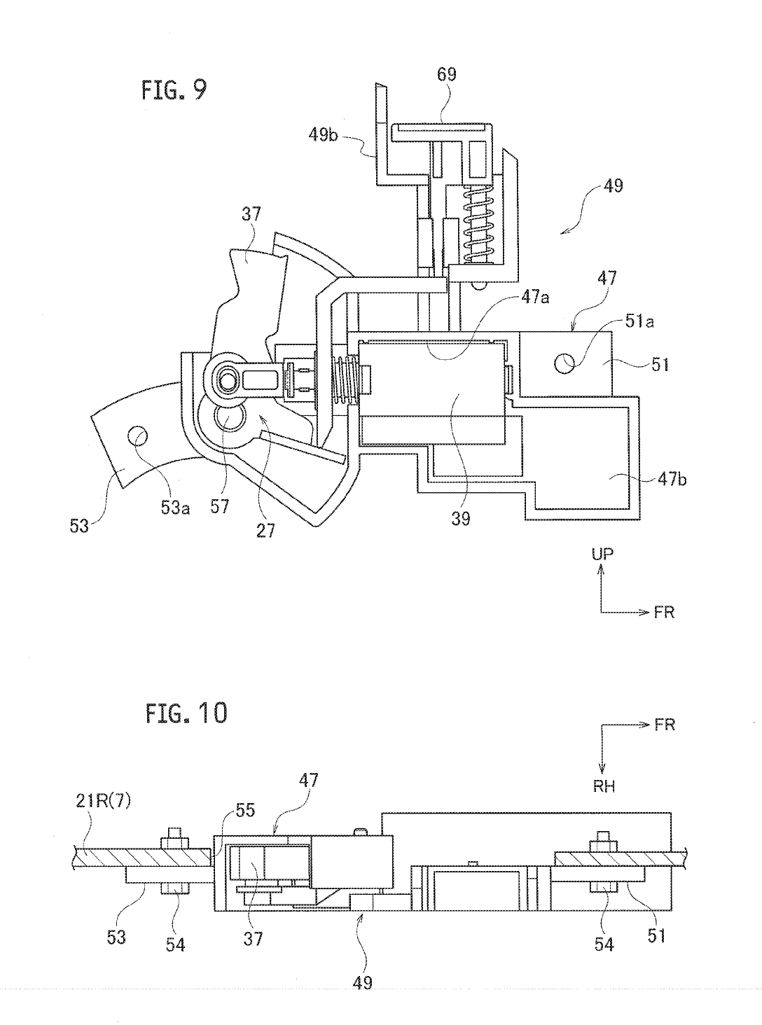

As shown in FIGS. 8 and 9, the aforementioned lock member 37 and solenoid 39 that constitute the shift lock mechanism 27 are attached to a unit base 47 provided separately from the casing 7, thereby collectively constituting a lock mechanism unit 49.

The unit base 47 includes a front attachment portion 51 located at a front part and extending forward, and a rear attachment portion 53 located at a rear part and extending rearward. The unit base 47 is attached to the right side wall 21R of the casing 7 with bolts 54 as shown in FIG. 10 by use of attachment holes 51a and 53a provided in the front attachment portion 51 and the rear attachment portion 53, respectively.

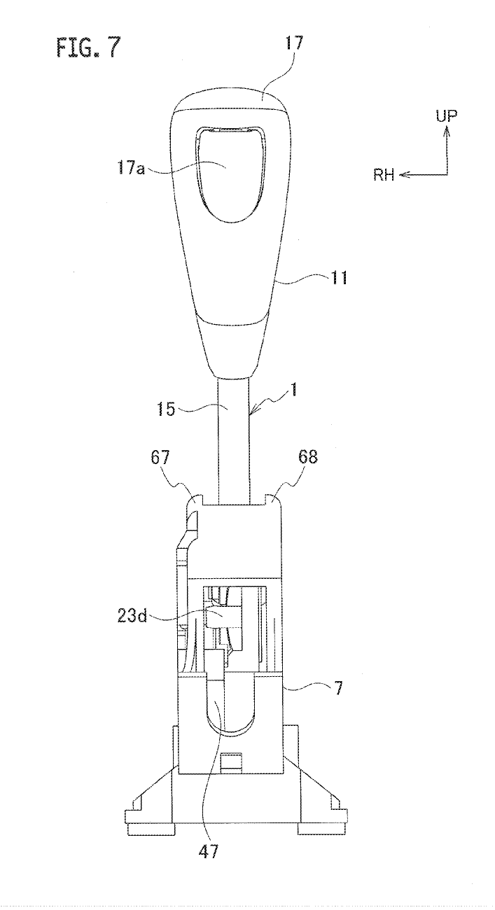

At this time, a substantial part of the unit base 47 except the front attachment portion 51 and the rear attachment portion 53 are put in an opening 55 as a through-hole provided in the right side wall 21R of the casing 7. As shown in FIG. 7, part of the unit base 47 put in the opening 55 is located below the cable coupler 23d that is shown in FIG. 5. The front attachment portion 51 and the rear attachment portion 53 of the unit base 47 are in contact with a surface of the right side wall 21R.

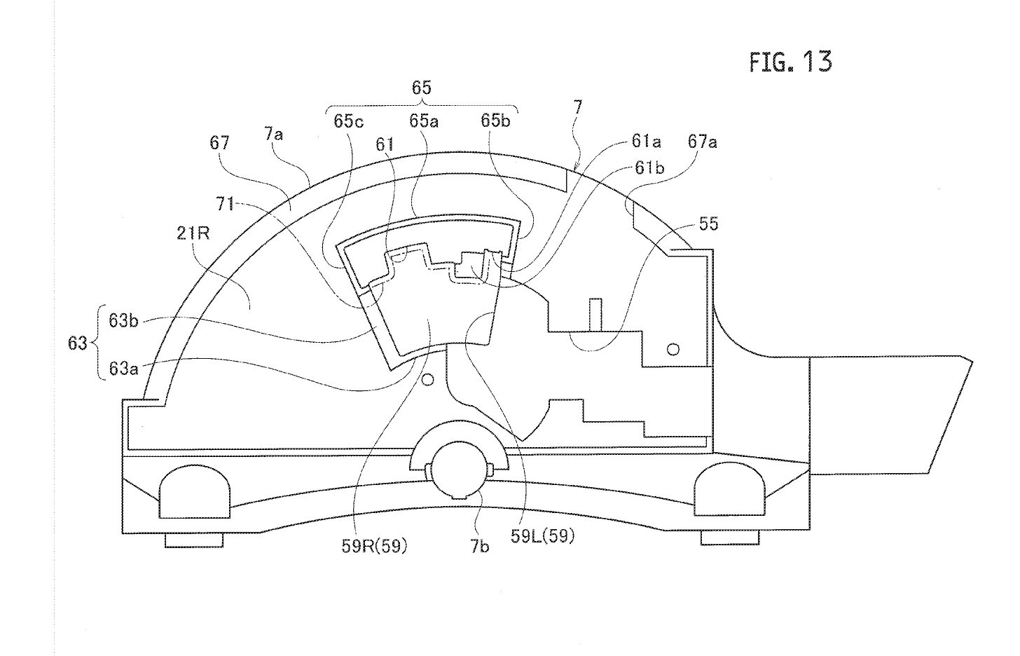

The lock member 37 is rotatably and pivotally supported by a lock shaft 57 erected outward on the unit base 47, and moves between a locked position and the unlocked position. At the locked position, the lock member 37 traverses an opening of a parking groove portion 61a shown in FIGS. 3 and 13, thereby restricting downward movement of the positioning pin 35 located in the parking groove portion 61a. At the unlocked position, the lock member 37 is detached from a lower part of the parking groove portion 61a, thereby allowing the downward movement of the positioning pin 35.

The solenoid 39 is linked to the lock member 37 and a movable portion of the solenoid 39 is displaced so as to locate the lock member 37 at the locked position or the unlocked position. The solenoid 39 is housed in a solenoid housing portion 47a (FIGS. 8 and 9) formed on an outer surface of the unit base 47, and is held in the solenoid housing portion 47a by a not-illustrated lock claw to be locked with an outer peripheral edge of the solenoid housing portion 47a.

As shown in FIGS. 8 and 9, a socket housing portion 47b is formed at a portion on the outer surface of the unit base 47 below the front attachment portion 51. A socket of a not-illustrated electric wire to be connected to the solenoid 39 is housed in the socket housing portion 47b.

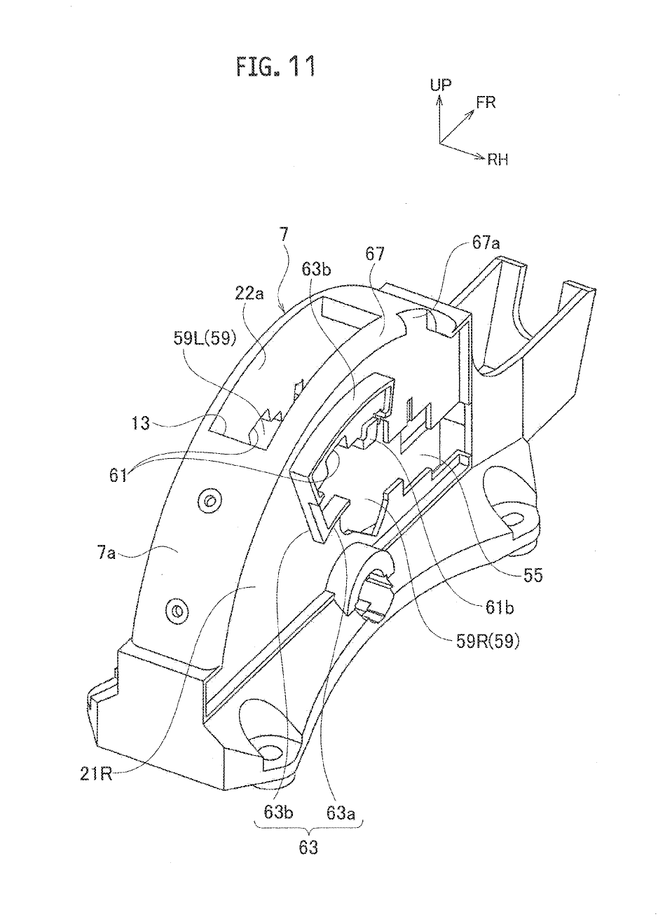

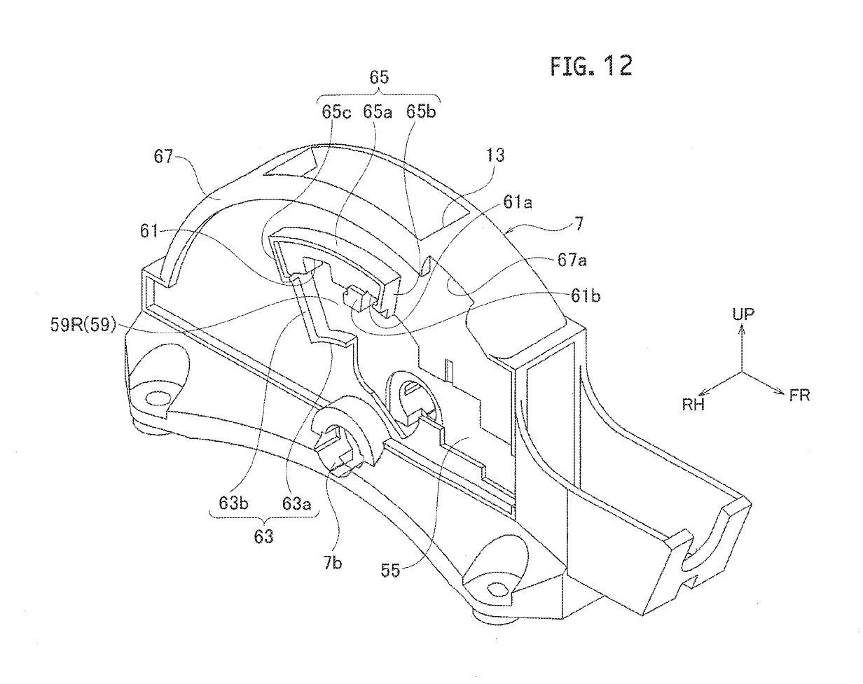

As shown in FIGS. 11 to 13, a rear part of the opening 55 of the right side wall 21R, in which the lock mechanism unit 49 is to be housed and held, is continuous to a front part on a lower side of a detent hole 59R (59) formed in the right side wall 21R. The left side wall 21L at a portion of the casing 7 on the backside of the sheet in FIG. 13 is also provided with a detent hole 59L (59) having the same shape as the detent hole 59R (59). The left side wall 21L is not provided with an opening 55.

The left and right detent holes 59L and 59R are located at such positions facing each other in the left-right direction and are provided in a penetrating manner in the left-right direction. Each of the detent holes 59L and 59R is provided with detent grooves 61 at its upper edge portion. The detent grooves 61 are formed as a series of undulate recesses, which are arranged along the swinging direction of the shift lever 11 and represent the respective positions. Protrusions and recesses of the detent grooves 61 are formed to be engageable with and disengageable from the positioning pin 35, which reciprocates in the axial direction of the shift lever 11, in the swinging direction of the shift lever 11.

In other words, when the shift lever 11 is located at the parking position, the positioning pin 35 is located at the parking groove portion 61a, which is set in one of the detent grooves 61, in the state of being biased to and held at the engagement position.

In this case, if the shift lever 11 is subjected to the swing operation without pressing the knob button 17a in an attempt to change the shift lever 11 from the parking position to another position, the positioning pin 35 is locked by one protrusion provided with a projection 61b out of the protrusions and recesses in the detent grooves 61, and the movement of the shift lever 11 to the other position is thus restricted. When the shift lever 11 is subjected to the swing operation while pressing the knob button 17a, the positioning pin 35 moves to the release position and across the protrusion in the detent groove 61 provided with the projection 61b, thereby allowing the shift lever 11 to move to the other position.

The detent hole 59R includes a first flange 63, which is provided on peripheral edges except peripheral edges of the detent grooves 61, and is erected from the right side wall 21R. As shown in FIG. 13, the first flange 63 is provided with a lower peripheral edge flange 63a of an arc shape located at a lower part of the detent hole 59R being continuous to the opening 55, and a rear peripheral edge flange 63b located at a rear part of the detent hole 59R, and is formed substantially into an L-shape as a whole.

As shown in FIG. 13, on a certain part of the right side wall 21R at a location surrounding three sides of the detent grooves 61, namely, an upper part, a front part, and a rear part thereof, there is formed a second flange 65 in such a way as to surround the detent grooves 61. The second flange 65 includes an upper flange 65a located on an upper part of the detent grooves 61 and formed in an arc shape, and a front flange 65b and a rear flange 65c located at the front and rear of the detent grooves 61, respectively.

The second flange 65 is formed to have a height of rise from the right side wall 21R on the sheet surface in FIG. 13 to the near side, which is larger than that of the first flange 63. Moreover, the rear flange 65c and the rear peripheral edge flange 63b are linearly connected to each other. Meanwhile, each of the lower peripheral edge flange 63a and the upper flange 65a is formed into a shape of an arc with the support shaft 9 shown in FIG. 3 as the center.

Of the above-mentioned projection 61b out of the protrusions and recesses in the detent grooves 61 to be locked with the positioning pin 35, a height of rise from the right side wall 21R on the sheet surface in FIG. 13 to the near side is equal to the height of rise of the second flange 65 from the right side wall 21R.

On the right side wall 21R of the casing 7, a rib 67 is formed along an edge portion on an outer peripheral side of the upper surface 7a. A height of rise of the rib 67 from the right side wall 21R on the sheet surface in FIG. 13 to the near side is equal to or below the height of rise of the first flange 63 from the right side wall 21R. An outer surface of the rib 67 has an arc shape which is continuous with the upper surface 7a.

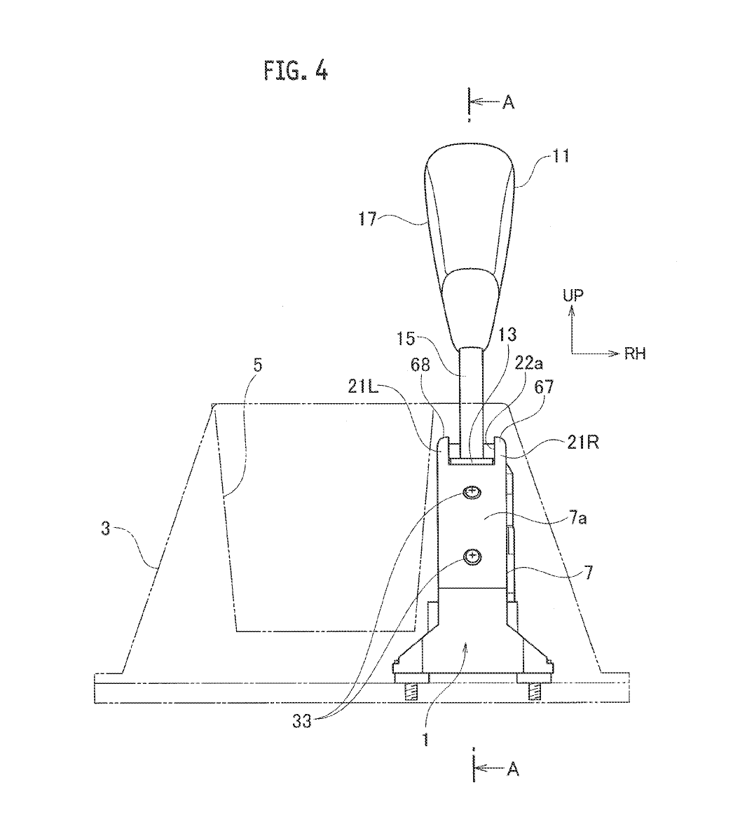

In the rib 67, a cutout portion 67a is formed at a position above the opening 55. As shown in FIG. 3, a release lever 69 for the lock mechanism unit 49 is provided at the position corresponding to the cutout portion 67a. The release lever 69 is slidably supported by a guide portion 49b integrally formed to the lock mechanism unit 49. The lock member 37 moves to the release position by pressing the release lever 69 downward through the cutout portion 67a by using a tool or the like. Note that a rib 68 which is substantially the same as the rib 67 is also formed on the left side wall 21L of the casing 7 as shown in FIGS. 4 and 6.

As shown in FIG. 13, a cushioning member 71 made of a plate-shaped soft resin and the like is attached by using an adhesive or the like to the right side wall 21R near the detent grooves 61 surrounded by the second flange 65. Of the cushioning member 71, three peripheral edges on its outer side substantially come into contact with an inner surface of the second flange 65, while a peripheral edge on its inner side slightly projects from end edges of the protrusions and recesses defining the detent grooves 61 toward the detent hole 59R. The portion of the cushioning member 71 projecting toward the detent hole 59R is illustrated with a chain dashed line in Fig, 13, and is omitted in other drawings.

A leading end position of the second flange 65 is set at the same position as positions of respective end portions of the lock member 37, the solenoid 39, and the unit base 47 projecting from the right side wall 21R (to the near side of the sheet in FIG. 13), in the state where the unit base 47 is attached to the casing 7.

Next, the operation and effect of this embodiment will be described.

(1) As shown in FIG. 5, the cable coupler 23d is provided on the front side in the swinging direction of the shift lever 11 and the cylinder 23e of the check mechanism 25 is provided on the rear side thereof, respectively. Thus, the cable coupler 23d, the shift lever 11, and the check mechanism 25 are disposed along the swinging direction of the shift lever 11. Accordingly, it is possible to further reduce an interval between the left and right side walls 21L and 21R in the casing 7, and to achieve reduction in size while reducing a width in the vehicle width direction of the shift lever device 1 as a whole.

(2) As shown in FIGS. 8 and 9, the unit base 47 including the shift lock mechanism 27 is provided separately from the casing 7 and is housed and disposed in the opening 55 of the right side wall 21R of the casing 7 as shown in FIG. 10. Here, the width in the left-right direction of the shift hole 13 is set equal to the width between the inner surfaces of the left and right side walls 21L and 21R. Accordingly, it is possible to further reduce the interval between the left and right side walls 21L and 21R of the casing 7, and to achieve the reduction in size while reducing the width in the vehicle width direction of the shift lever device 1 as a whole.

(3) The leading end position of the second flange 65 provided on a peripheral edge of the detent hole 59R is set at the same position as the respective end portions of the lock member 37, the solenoid 39, and the unit base 47 projecting from the right side wall 21R. This makes it possible to reduce the width in the vehicle width direction of the shift lever device 1 while securing rigidity of the casing 7, even in the case of providing the opening 55 that is continuous to the detent hole 59R and is provided for housing and disposing the unit base 47.

(4) At least the side wall 21R out of the pair of left and right side walls 21L and 21R of the casing 7 is provided with the rib 67 along the edge portion on the outer peripheral side, the rib 67 having the height equal to or below the height of rise of the second flange 65 from the right side wall 21R. Thus, the casing 7 can improve the rigidity by suppressing a pressure concentration on a corner portion of the upper surface 7a, while suppressing the width in the vehicle width direction of the shift lever device 1 at a small width.

(5) As shown in FIG. 7, part of the unit base 47 put in the opening 55 of the right side wall 21R is located below the cable coupler 23d. Accordingly, it is possible to suppress inhibition of an action of the cable 34 shown in FIG. 5 by the unit base 47. In addition, it is further possible to suppress the width in the vehicle width direction of the shift lever device 1 to a smaller width as compared to that in the case of disposing part of the unit base 47 put in the opening 55 and the cable coupler 23d in arrangement in the vehicle width direction.

(6) By providing the unit base 47 separately from the casing 7, only the opening 55 needs to be formed to simply penetrate the right side wall 21R without having to provide the right side wall 21R with recesses for housing the lock member 37 and the solenoid 39. Thus, formability of the casing 7 is improved.

(7) The rigidity around the detent grooves 61 is improved by the second flange 65 having the larger height of rise than that of the first flange 63. Thus, the rigidity of the casing 7 can be secured even when the opening 55 is continuous to the detent hole 59R.

(8) By providing the cushioning member 71 to part of the right side wall 21R at the position surrounded by the second flange 65 as shown in FIG. 13, it is possible to reduce occurrence of clapping sounds when the positioning pin 35 moves from below upward and gets engaged with the detent grooves 61.

(9) When the shift lever 11 is moved back and force in the state where the positioning pin 35 is engaged with any of the detent holes 61 at the parking position or the reverse position, a large force acts on one of the protrusions of the detent grooves 61. However, as shown in FIGS. 11 to 13, the protrusion of the detent groove 61 between the parking position and the reverse position includes the projection 61b erected from the right side wall 21R and the height of rise of the projection 61b is made equal to the height of rise of the second flange 65 from the right side wall 21R, whereby the rigidity around the projection is increased. Thus, it is possible to suppress cracks or breakages around the projection.

(10) The shift lever device 1 reduced in profile and size by further reducing the width in the vehicle width direction thereof can be disposed compactly beside the cup holders 5 in the center console 3 of the automobile as shown in FIGS. 1 to 4.

The embodiment of the present invention has been described above. It is to be noted, however, that the embodiment is merely an example described in order to facilitate the understanding of the present invention. In this context, the present invention is not limited to the above-described embodiment. Without limitations to the specific technical matters as disclosed in conjunction with the above-described embodiment, the technical scope of the present invention encompasses various modifications, changes, alternative techniques, and the like which can easily be derived therefrom.

For example, in the above-described embodiment, the cup holders 5 are disposed in the center console 3 beside the shift lever device 1. However, other components such as a change box and switches may be disposed beside the shift lever device 1 instead.

In the above-described embodiment, the first flange 63, the second flange 65, the projection 61b, and the cushioning member 71 are provided only to the right side wall 21R. However, these constituents may also be provided to the left side wall 21L in addition to the right side wall 21R.

In the above-described embodiment, as shown in FIG. 5, the check block 31 is fixed to the concave inner surface 7c of the casing 7 by using the screws 33. Instead, the check block 31 may be integrated with the casing 7.

In the above-described embodiment, the guide portion 49b which slidably supports the release lever 69 is integrally formed to the lock mechanism unit 49. Instead, the guide portion 49b may be integrated with the casing 7.

What is claimed is:

1. A shift lever device comprising:
a casing attached to a vehicle body;
a shift lever inserted into a shift hole having a shape of an elongated hole opened to an upper surface of the casing and configured to swing along the shift hole;
a check mechanism provided between the casing and the shift lever, and configured to impart click feeling to each of positions set within a swinging range of the shift lever when the shift lever is put into a swing operation; and
a shift lock mechanism configured to come into engagement with the shift lever and thus to restrict movement of the shift lever from a parking position to another position being the positions set within the swinging range of the shift lever, wherein
the check mechanism includes
a check member provided to the shift lever, and held while being biased in a protruding direction, and
a check block provided to the casing and having a check groove to be pressed by the check member which swings together with the shift lever,
a coupler for a cable, of which one end is connected to a transmission, is integrally provided on one side in a swinging direction of the shift lever, and a guide member configured to guide the check member is integrally provided on another side in the swinging direction of the shift lever,
the shift lock mechanism includes
a lock member configured to come into engagement with a positioning pin located at the parking position of the shift lever and thus to block movement in an axial direction of the positioning pin, and
a drive unit configured to move the lock member to an unlocked position where the lock member does not come into engagement with the positioning pin,
the shift lock mechanism is attached to a unit base provided separately from the casing,
the casing is formed such that a width in a left-right direction of the shift hole is equal to a width between inner surfaces of a pair of left and right side walls of the casing, and that a through-hole in which the unit base is to be housed and disposed is provided in one of the pair of left and tight side walls of the casing,
a detent hole is penetratingly provided in each of the pair of left and right side walls of the casing, the detent hole being provided with a detent groove to come into engagement with the positioning pin in the swinging direction of the shift lever,
one of the detent holes provided in the pair of left and right side walls of the casing is continuous to the through-hole,
the detent hole continuous to the through-hole includes a flange provided on a peripheral edge of the detent hole and erected from the side wall, and
a leading end position of the flange is set at the same position as positions of respective end portions of the lock member, the drive unit, and the unit base projecting from the side wall.

2. The shift lever device according to claim 1, wherein at least one of the pair of left and right side walls of the casing includes a rib formed along an edge portion on an outer peripheral side of the side wall, and having a height equal to or below a height of rise of the flange from the side wall.

3. The shift lever device according to claim 1, wherein
the flange comprises:
a first flange provided on a peripheral edge except a peripheral edge of the detent groove; and
a second flange provided in such a way as to surround the detent groove, and having a height of rise from the side wall being higher than a height of rise of the first flange from the side wall,
a cushioning member is provided on the detent groove side of the second flange, in such a way as to project more to the detent hole side than an end edge of the detent groove does, and a protrusion of the detent groove between the parking position and a reverse position includes a projection erected from the side wall, and a height of rise of the protrusion is equal to the height of rise of the second flange from the side wall.
